(19) United States
(12) Patent Application Publication
(10) Pub. No.: US 2024/0240779 A1
(43) Pub. Date: Jul. 18, 2024

(54) LAMP MOUNTING STRUCTURE AND LAMP

(71) Applicants: SUZHOU OPPLE LIGHTING CO., LTD., Suzhou City (CN); OPPLE LIGHTING CO., LTD., Shanghai (CN)

(72) Inventors: Jianmin XIE, Suzhou City (CN); Qingquan ZHANG, Suzhou City (CN); Xingchen TAN, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 18/437,529

(22) Filed: Feb. 9, 2024

Related U.S. Application Data
(63) Continuation of application No. PCT/CN2022/111311, filed on Aug. 10, 2022.

(30) Foreign Application Priority Data
Aug. 11, 2021 (CN) 202110917473.8
Aug. 11, 2021 (CN) 202121867723.3

(51) Int. Cl. F21V 21/30

(52) U.S. Cl. CPC F21V 21/30

(57) ABSTRACT

Provided in the present disclosure are a lamp mounting structure and a lamp. The lamp mounting structure is used for assembling the lamp on a mounting wall and comprises: a mounting assembly, a connecting assembly and a base plate assembly, wherein the mounting assembly is fixedly installed on the mounting wall, and the base plate assembly is fixedly connected to a lamp main body of the lamp; the mounting assembly, the connecting assembly and the base plate assembly are rotatably connected end-to-end in sequence to form a Z-shaped structure; and a first lock catch part is arranged on the mounting assembly, at least one second lock catch part is arranged in a position, corresponding to the first lock catch part, of the base plate assembly, and the first lock catch part is connected to the second lock catch part in a lock catch manner.

### CROSS REFERENCES TO RELATED APPLICATIONS

This application claims the priority of PCT patent application No. PCT/CN2022/111311 filed on Aug. 10, 2022 which claims the priority of the Chinese patent application with an application number 202110917473.8 and filed on Aug. 11, 2021, and the Chinese patent application with an application number 202121867723.3 filed on Aug. 11, 2021, and the entire contents of which are incorporated by reference herein for all purposes.

### TECHNICAL FIELD

The present disclosure relates to the technical field of lighting devices, and in particular, to a lamp mounting structure and a lamp.

### BACKGROUND

Ceiling lamps have become the most common ceiling lamp for indoor lighting due to their characteristics such as being closer to natural lighting. They are widely used in various occasions such as homes, offices, and entertainment venues.

### SUMMARY

The present disclosure provides a lamp mounting structure.

The present disclosure provides a lamp mounting structure that may be for assembling a lamp on a mounting wall, and the lamp mounting structure may include: a mounting assembly, a connection assembly, and a chassis assembly.

The mounting assembly may be fixedly installed on the mounting wall, the chassis assembly may be fixedly connected to a lamp main body, the mounting assembly, the connection assembly, and the chassis assembly may be rotatably connected end-to-end in sequence to form a Z-shaped structure.

The mounting assembly may be provided with a first lock catch part, and at least one second lock catch part may be provided on the chassis assembly at a position corresponding to the first lock catch part, and the first lock catch part may be connected to the second lock catch part in a lock catch manner.

It is to be understood that both the foregoing general description and the following detailed description are exemplary and explanatory only and are not restrictive of the present disclosure.

### BRIEF DESCRIPTION OF DRAWINGS

The technical solutions and other beneficial effects of the present disclosure will be understood through a detailed description of the examples of the present disclosure in conjunction with the accompanying drawings.

FIG. 1 is a perspective view of the lamp mounting structure according to first example of the present disclosure.

FIG. 2 is a perspective view of the mounting assembly of FIG. 1.

FIG. 3 is a partial enlarged view of FIG. 2.

FIG. 4 is a perspective view of the connection assembly of FIG. 1.

FIG. 5 is a perspective view of the snap-fit assembly in FIG. 1.

FIG. 6 is a perspective view of FIG. 1 with the connection assembly and the mounting assembly removed.

FIG. 7 is a perspective view of the self-locking structure in FIG. 1.

FIG. 8 is a perspective view of the self-locking structure of FIG. 7 from another angle.

FIG. 9 is a perspective view of the second lock catch part in FIG. 1.

FIG. 10 is a perspective view of the lamp mounting structure according to second example of the present disclosure.

FIG. 11 is a perspective view of the mounting assembly of FIG. 10.

FIG. 12 is a partial enlarged view of FIG. 10.

FIG. 13 is another partial enlarged view of FIG. 10.

FIG. 14 is a perspective view of the connection assembly of FIG. 10.

FIG. 15 is a perspective view of the first connection assembly in FIG. 14.

FIG. 16 is a perspective view of the second connection assembly in FIG. 14.

FIG. 17 is a partial enlarged view of FIG. 16.

FIG. 18 is another partial enlarged view of FIG. 16.

FIG. 19 is a perspective view of the position limiting elastic piece and the disassembly assembly in FIG. 16.

FIG. 20 is a partial cross-sectional view of FIG. 16.

FIG. 21 is a perspective view of FIG. 10 with the connection assembly and the mounting assembly removed.

FIG. 22 is a perspective view of the snap-fit assembly in FIG. 10.

FIG. 23 is a perspective view of the second lock catch part in FIG. 10.

### DETAILED DESCRIPTION

In order to make the purpose, technical solutions and advantages of the present disclosure clearer, the present disclosure will be described in detail below with reference to the accompanying drawings and examples.

Here, it should be noted that, in order to avoid obscuring the present disclosure with unnecessary details, only the structures and/or processing steps closely related to the solution of the present disclosure are shown in the drawings, and other details that are less relevant to the present disclosure are omitted.

Additionally, it should be noted that the terms “comprise,” “comprising,” “include,” “including,” or any other variation thereof are intended to cover a non-exclusive inclusion, such that a process, method, article, or device that includes a list of elements includes not only those elements, but also includes other elements not expressly listed or includes that are inherent to the process, method, article or device.

Some ceiling lamps include a bottom shell, a light source, and a lampshade. When installing, most of the ceiling lamps need to remove the lampshade or to remove both the lampshade and the light source, fix the chassis on the wall or ceiling, and then install wires of the light source, and finally mount the lampshade on the chassis. Due to the large area of the ceiling lamp, the visual conditions are extremely poor, and it is operated at high altitudes, the installation process is complicated and requires the assistance of many people to complete the installation. The installation is difficult and expensive, and the installation efficiency is low. Moreover, in the later maintenance and cleaning process of the ceiling lamp, due to the inconvenience of installation and disassembly, it also takes time and effort for the staff to disassemble and assemble.

Especially during the installation process of large-weight ceiling lamps, it is basically impossible for one person to carry the lamps and work at high altitudes. It is also easy to damage the ceiling lamps when multiple people work together. During the installation process, it is also easy to block the clamping position due to visual issues, which cannot meet the transposition requirements for suspended operations. The installation process is time-consuming and labor-intensive, and the installation cost is high.

In view of this, it is indeed necessary to provide a lamp mounting structure and a lamp to solve the above problems.

### First Example

Please refer to FIG. 1 to FIG. 9, a lamp mounting structure 100 is provided by the first example of the present disclosure. The lamp mounting structure 100 includes a mounting assembly 1, a connection assembly 2, and a chassis assembly 3. The mounting assembly 1 is fixedly installed on the mounting wall, and the chassis assembly 3 is fixedly connected to the lamp main body (not shown), and the mounting assembly 1, the connection assembly 2, and the chassis assembly 3 are rotatably connected end-to-end in sequence to form a Z-shaped structure. This arrangement can solve the problems of poor viewing angle when aligning and installing the lamp, and at the same time realize the transposition requirements for suspended operations, making the installation process of lamps time-saving, labor-saving, efficient, safe, and can be installed and disassembled by a single person.

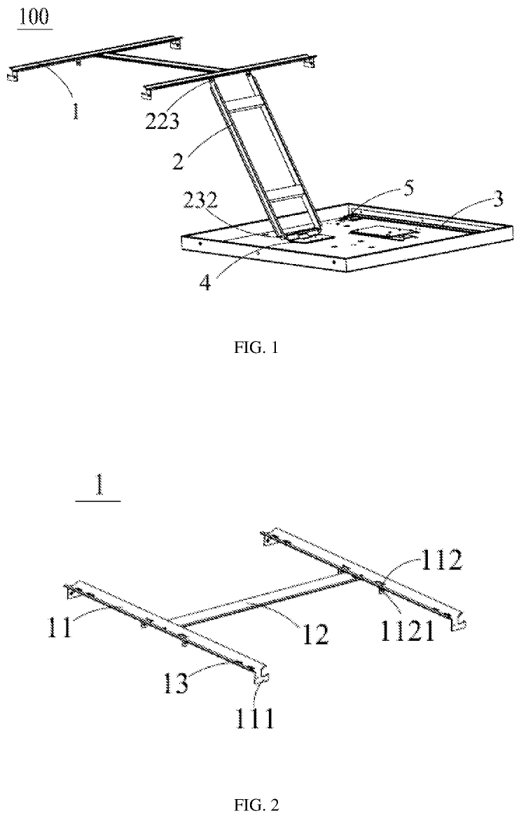

Please refer to FIG. 2, and in conjunction with FIG. 1, the mounting assembly 1 is made of conventional plates and can be made into the required shape according to customer requirements and installation environment, such as round, square, I-shaped, etc., which is not limited by this disclosure. In an example of the present disclosure, the mounting assembly 1 includes a pair of first mounting parts 11 arranged in parallel and a second mounting part 12 arranged vertically to the two first mounting parts 11 and arranged between the two first mounting parts 11. The two ends of the second mounting part 12 are fixed to the middle parts of the two first mounting parts 11 respectively, so that the entire mounting assembly 1 has an I-shaped structure. By arranging the I-shaped mounting assembly 1, the mounting assembly 1 has a simplified structure, is convenient to produce, has the advantages of stable installation and strong load-bearing capacity, and can be widely used for installing various types of ceiling lamps, chandeliers and other lamps. Preferably, the two long sides of the first mounting part 11 extend downwardly and inwardly from the edge part to the middle part, so that the first mounting part 11 has an arc-shaped structure. A mounting hole 13 is provided in each first mounting part 11, and the mounting assembly 1 is fixed on the mounting wall by using fasteners such as expansion screws. It can be understood that the mounting wall can be a wall, a suspended ceiling or a room ceiling, which is not limited in this disclosure.

The mounting assembly 1 is provided with a first lock catch part 111, and the chassis assembly 3 is provided with at least one second lock catch part 5 at a position corresponding to the first lock catch part 111. The first lock catch part 111 is connected with the second lock catch part 5 in a lock catch manner. By arranging the locking engagement between the first lock catch part 111 and the second lock catch part 5, the installation difficulty of the lamp is reduced, the installation efficiency of the lamp is improved, single-person installation and disassembly is realized, and the installation cost is reduced. It should be noted that the specific number and arrangement positions of the first lock catch parts 111 and the second lock catch parts 5 are not limited in this disclosure, as long as the first lock catch part 111 and the second lock catch part 5 are set correspondingly, and the first lock catch part 111 and the second lock catch part 5 can also be flexibly set according to the specific structure of the mounting assembly 1 and the lamp.

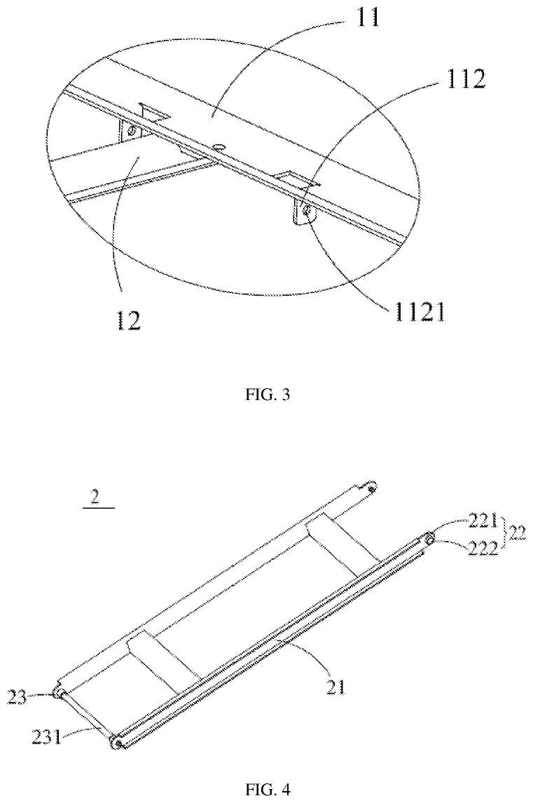

Please continue to refer to FIG. 2 to FIG. 3, the first lock catch part 111 is provided on the side of the first mounting part 11 away from the mounting wall. Four first lock catch parts 111 are provided. Each first lock catch part 111 is located at an end of the first mounting part 11 and the first lock catch parts 111 are symmetrically distributed on both sides of the first mounting part 11. With this arrangement, the lamp can be hung on the mounting assembly 1 stably and with balanced force during the installation process. Of course, two first lock catch parts 111 may also be provided. The two first lock catch parts 111 are respectively provided on the first mounting part 11 and are symmetrically provided on both sides of the second mounting part 12. In addition, the first lock catch part 111 may not be provided at the end of the first mounting part 11, or may be provided at other positions of the first mounting part 11, which is not limited in this disclosure.

The end of each first mounting part 11 at the side of the first mounting part 11 away from the mounting wall extends downwardly to form an L-shaped first lock catch part 111. Preferably, the L-shaped first lock catch part 111 is an L-shaped hook. The horizontal extension direction of each hook is the same to facilitate locking engagement with the second lock catch part 5 on the chassis assembly 3. Of course, the horizontal extension directions of the hooks located at the two ends of the first mounting part 11 can also be different, as long as they can be connected with the second lock catch part 5 in a locking manner. It should be noted that the first lock catch part 111 can be integrally formed with the first mounting part 11, or can be assembled and arranged on the first mounting part 11.

Please refer to FIG. 4, the connection assembly 2 includes a pair of connection rods 21 arranged in parallel and a first connection part 22 and a second connection part 23 located at both ends of the connection rods 21. The mounting assembly 1 is rotatably connected to the first connection part 22, and the chassis assembly 3 is rotatably connected to the second connection part 23 to form a first rotating part 223 and a second rotating part 232 respectively. Such an arrangement can make the connection assembly 2 have sufficient strength, and the lamp main body can be temporarily placed in the air to meet the transposition requirements of suspended operations.

The first connection part 22 includes a first connection hole 221 and a connection piece 222. The side of the mounting assembly 1 away from the mounting wall extends downward at a position corresponding to the first connection part 22 to form a third connection part 112 (please refer to FIG. 2 and FIG. 3). The third connection part 112 is provided with a second connection hole 1121 at a position corresponding to the first connection hole 221. The connection piece 222 passes through the first connection hole 221 and the second connection hole 1121 to rotatably connect the mounting assembly 1 and the first connection part 22. The connection piece 222 may be a rotating pin, a rotating rivet, a rotating shaft, etc., which is not limited in this disclosure. The first connection part 22 and the third connection part 112 are rotatably connected through the connection piece 222 so that the connection assembly 2 can freely rotate around the first rotating part 223 to drive the chassis assembly 3 to move closer to the mounting assembly 1.

The second connection part 23 includes a rotating shaft 231, and the connection assembly 2 is rotatably connected to the chassis assembly 3 through the rotating shaft 231. The connection assembly 2 can be directly and rotatably connected to the chassis assembly 3 through the second connection part 23, or can also be rotatably connected to the chassis assembly 3 through the snap-fit assembly 4. In one example of the present disclosure, a bracket (not shown) is provided on the side of the chassis assembly 3 facing the connection assembly 2 at a position corresponding to the second connection part 23, and a third connection hole (not shown) is provided in the bracket. The rotating shaft 231 of the second connection part 23 passes through the third connection hole and is rotatably connected to the bracket. In order to improve the connection strength between the connection assembly 2 and the chassis assembly 3, preferably, the connection assembly 2 is rotatably connected to the chassis assembly 3 through the snap-fit assembly 4.

Please refer to FIG. 5, the lamp mounting structure 100 further includes a snap-fit assembly 4. The snap-fit assembly 4 is fixedly connected to the side of the chassis assembly 3 facing the connection assembly 2 through welding, riveting fasteners, or the like. The second connection part 23 is rotatably connected with the chassis assembly 3 through the snap-fit assembly 4.

The snap-fit assembly 4 includes a first snap-fit member 41 and a second snap-fit member 42. Preferably, the first snap-fit member 41 is made of a hard material such as sheet metal, and the second snap-fit member 42 is made of an elastic material such as an elastic piece. Through the cooperation of the first snap-fit member 41 and the second snap-fit member 42, the second connection part 23 of the connection assembly 2 is fixed in the snap-fit assembly 4, and the second connection part 23 can be freely rotated in the snap-fit assembly 4.

The first snap-fit member 41 includes a plate-shaped first fixing part 411. The first fixing part 411 is fixedly connected to the chassis assembly 3 through fasteners. One end of the first fixing part 411 close to the connection assembly 2 is bent upward and inward to form a bent part 412. A receiving groove 413 is formed between the bent part 412 and the first fixing part 411. The rotating shaft 231 of the second connection part 23 passes through the receiving groove 413 and is rotatably connected to the first snap-fit member 41. The end of the bent part 412 extends obliquely towards a direction away from the first fixing part 411 to form a guide part 414. The guide part 414 can guide the rotating shaft 231 of the second connection part 23 to quickly snap into the receiving groove 413.

The second snap-fit member 42 includes a plate-shaped second fixing part 421, and the second fixing part 421 is fixedly connected to the first fixing part 411. Preferably, a surface of the second fixing part 421 is attached on the first fixing part 411, and the second fixing part 421 and the first fixing part 411 are fixedly connected to the chassis assembly 3 through fasteners. The end of the second fixing part 421 close to the bent part 412 extends towards the interface part 415 where the bent part 412 and the guide part 414 are connected to form a position limiting part 422. The position limiting part 422 is in contact with the interface part 415 for position limiting, so that the rotating shaft 231 of the second connection part 23 is limited and fixed in the receiving groove 413. Because the second snap-fit member 42 is an elastic piece, when the rotating shaft 231 of the second connection part 23 enters the receiving groove 413 under the guidance of the guide part 414 or when the rotating shaft is to be moved out of the receiving groove 413, the elastic piece undergoes clastic deformation under the action of an external force, so as to facilitate the rotating shaft 231 to enter the receiving groove 413 or to move the rotating shaft 231 out of the receiving groove 413. When the external force disappears, the elastic deformation of the elastic piece disappears and the clastic piece returns to the original position. By arranging the second snap-fit member 42 to be made of elastic material, the connection and disassembly of the connection assembly 2 and the snap-fit assembly 4 is facilitated and the installation efficiency is improved.

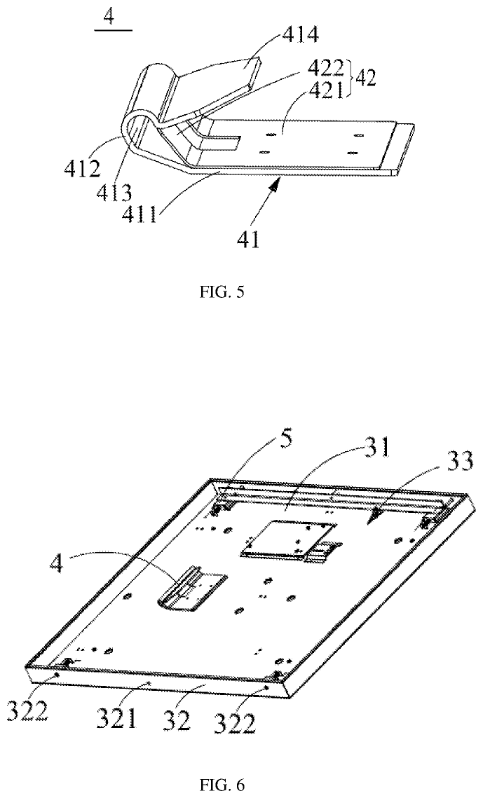

Please refer to FIG. 6, the chassis assembly 3 includes a bottom plate 31 and side walls 32 surrounding the bottom plate 31 and located at a periphery of the bottom plate 31. The side wall 32 extends in a direction from the periphery of the bottom plate 31 to a position close to the mounting assembly 1. The side walls 32 and the bottom plate 31 jointly form a receiving space 33 so as to receive the snap-fit assembly 4, the second lock catch part 5, and the connection assembly 2, so that the chassis assembly 3 can be installed on the mounting assembly 1 closely to improve the aesthetics of the lamp.

At least one second lock catch part 5 is arranged on the chassis assembly 3 at a position corresponding to the first lock catch part 111. The first lock catch part 111 and the second lock catch part 5 cooperate with each other in a lock catch manner to quickly lock the chassis assembly 3 with the mounting assembly 1 to complete the installation of the lamp. It can be understood that the shape of the second lock catch part 5 can be realized by different structures, as long as it can be used and matched with the first lock catch part 111. The number and position of the second lock catch parts 5 also correspond to the first lock catch parts 111, which are not limited by this disclosure.

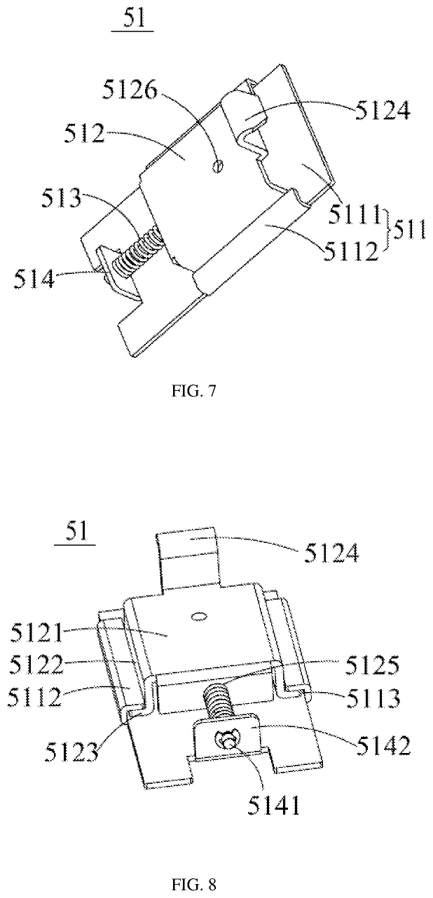

Please refer to FIG. 7 to FIG. 8, and in conjunction with FIG. 1, in an example of the present disclosure, the second lock catch part 5 includes a self-locking structure 51 and a detachment assembly 52. The detachment assembly 52 includes a detachment button 521 and a transmission part 522. Through the locking engagement between the self-locking structure 51 and the first lock catch part 111, and through the detachment button 521 and the transmission part 522 quickly unlocking the locking engagement between the self-locking structure 51 and the first lock catch part 111, quick installation and disassembly by a single person can be realized.

Please refer to FIG. 7 to FIG. 8, the self-locking structure 51 includes a slide rail 511, a sliding part 512, an elastic member 513, and a position limiting member 514. The slide rail 511 includes a horizontal part 5111 parallel to the chassis structure and a pair of position limiting edges 5112 extending upward and bent from the edge of the horizontal part 5111. The slide rail 511 is fixedly installed on the chassis assembly 3 through the horizontal part 5111. A sliding slot 5113 is formed between the horizontal part 5111 and the position limiting edge 5112, and the sliding part 512 is slidably connected to the slide rail 511 through the sliding slot 5113. Further, the sliding part 512 includes a sliding cover 5121 and a side edge 5122 extending from an edge of the sliding cover 5121 towards a direction close to the horizontal part 5111. A pair of side edges 5122 corresponding to the position limiting edge 5112 extends towards a connection direction of the position limiting edge 5112 and the horizontal part 5111 to form a sliding edge 5123 parallel to the horizontal part 5111. The sliding edge 5123 is located and limited in the sliding slot 5113 under the action of the position limiting edge 5112, and can slide freely in the sliding slot 5113. A buckle part 5124 is provided at a position of the sliding part 512 corresponding to the first lock catch part 111 and is connected with the first lock catch part 111 in a lock catch manner. Preferably, the buckle part 5124 is an upside-down buckle that matches the L-shaped hook of the first lock catch part 111. The first lock catch part 111 and the buckle part 5124 are locked and connected through the cooperation of the buckle and the hook. The side edge 5122 of the sliding part 512 away from the buckle part 5124 is provided with a through hole 5125. The position limiting member 514 includes a position limiting shaft 5141 and a position limiting block 5142 vertically connected to the position limiting shaft 5141. One end of the position limiting shaft 5141 away from the position limiting block 5142 passes through the through hole 5125 and is slidably connected to the sliding part 512. The clastic member 513 is sleeved on the position limiting shaft 5141 and is clamped between the sliding part 512 and the position limiting block 5142. Preferably, the elastic member 513 is a spring that maintains the tendency to return to its original position when subjected to elastic deformation.

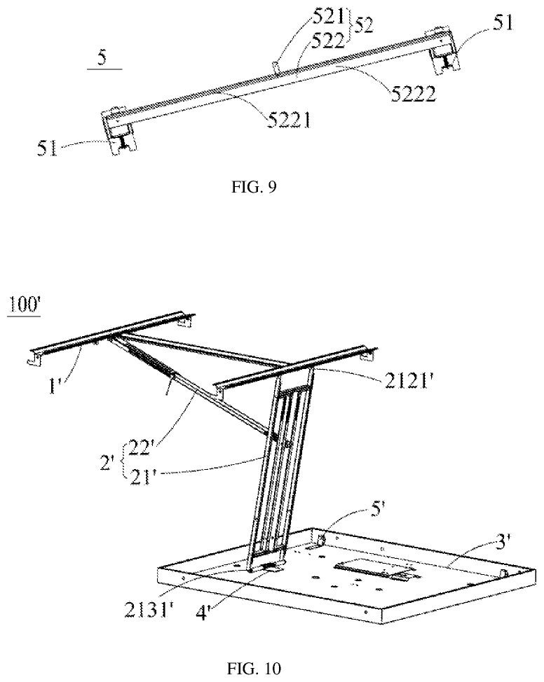

Referring to FIG. 9, the transmission part 522 includes a first transmission part 5221 parallel to the side wall 32 of the chassis assembly 3 and a second transmission part 5222 perpendicular to the first transmission part 5221. The fixing member passes through the third fixing hole 322 to fixedly connect the first transmission part 5221 to the side wall 32 of the chassis assembly 3. The disassembly button 521 passes through the first fixing hole 321 in the side wall 32 of the chassis assembly 3 and is fixedly connected with the first transmission part 5221 of the transmission part 522. The fixing member passes through the second fixing hole 5126 in the sliding cover 5121 to fixedly connect the second transmission part 5222 of the transmission part 522 and the sliding cover 5121 to drive the sliding part 512 to slide relative to the slide rail 511.

Furthermore, each self-locking structure 51 can be provided with a transmission part 522 and a disassembly button 521. By pressing the disassembly button 521, the locking engagement between the second lock catch part 5 and the first lock catch part 111 can be quickly unlocked. Preferably, in order to save costs and improve disassembly efficiency, the transmission part 522 is fixedly connected to the sliding parts 512 of the two self-locking structures 51 to drive the two sliding parts 512 to slide synchronously.

This disclosure further provides a lamp, which includes a lamp main body (not shown) and the aforementioned lamp mounting structure 100. The lamp main body and the side of the chassis assembly 3 facing away from the connection assembly 2 are fixedly connected through fasteners such as screws.

When the lamp needs to be installed, first rotatably connect the first connection part 22 of the connection assembly 2 and the mounting assembly 1 through the connection piece 222, then fix the mounting assembly 1 with the connection assembly 2 on the mounting wall, and then fixedly install the snap-fit assembly 4 and the second lock catch part 5 into the receiving space 33 of the chassis assembly 3, and then fixedly connect the lamp main body to the side of the chassis assembly 3 facing away from the connection assembly 2 through the fixing piece, then push up the chassis assembly 3 with the lamp main body so that the second connection part 23 of the connection assembly 2 is rotatably connected to the snap-fit assembly 4. In this case, due to the effective engagement of the connection assembly 2 and the snap-fit assembly 4, the lamp main body can be temporarily placed in the air to facilitate connection to the mains power, avoiding positioning difficulties due to line of sight, and improving visibility. Pushing the chassis assembly 3 upward again can cause the chassis assembly 3 to rotate around the first rotating part 223 between the connection assembly 2 and the mounting assembly 1, thereby realizing the upward rotational motion of the lamp main body around the rod, and at the same time realizing the transposition requirements for suspended operations. Through locking engagement of the second lock catch part 5 and the first lock catch part 111, the lamp main body is fixedly installed on the mounting assembly 1, and at the same time, the connection assembly 2 is received in the receiving space 33 of the chassis assembly 3, so as to improve the aesthetics of the lamp.

When it is necessary to disassemble the lamp main body, you only need to press the disassembly button 521. The disassembly button 521 drives the transmission part 522 to move towards the sliding part 512, so that the sliding cover 5121 moves on the position limiting shaft 5141 towards the position limiting block 5142, compressing the elastic member 513 to unlock the locking connection between the buckle part 5124 and the first lock catch part 111, and the lamp main body slowly leaves the mounting assembly 1, because the connection assembly 2 and the snap-fit assembly 4 are effectively engaged, so that the lamp main body can be temporarily fixed in the air to prevent the lamp main body from falling quickly to damage the lamp main body or cause safety accidents, and to achieve quick installation and disassembly by one person.

### Second Example

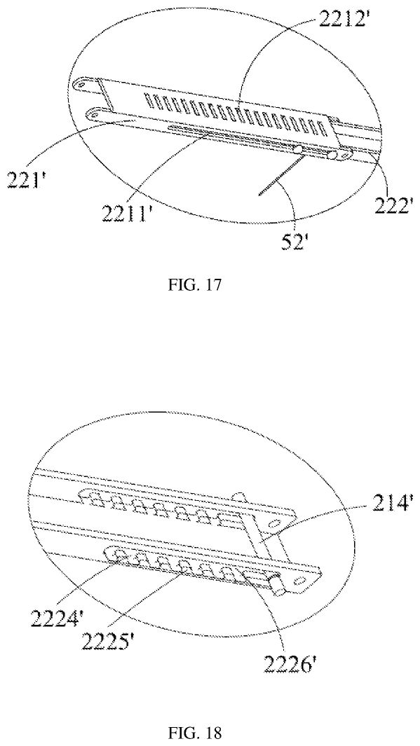

Referring to FIG. 10 to FIG. 23, the second example of the present disclosure provides a lamp mounting structure 100′, which includes: a mounting assembly 1′, a connection assembly 2′, and a chassis assembly 3′. The mounting assembly 1′ is fixedly installed on the mounting wall, the chassis assembly 3′ is fixedly connected to the lamp main body. The connection assembly 2′ includes a first connection assembly 21′ and a second connection assembly 22′. Both ends of the first connection assembly 21′ are rotatably connected to the mounting assembly 1′ and the chassis assembly 3′, respectively, to form a first rotating part 2121′ and a second rotating part 2131′; one end of the second connection assembly 22′ is rotatably connected to an end of the first mounting part 11′ away from the first rotating part 2121′, and the other end of the second connection assembly 22′ is rotatably connected to the second connection assembly 22′ located between the first rotating part 2121′ and the second rotating part 2131′. The mounting assembly 1′ is provided with a first lock catch part 111′, and a position of the chassis assembly 3′ corresponding to the first lock catch part 111′ is provided with at least one second lock catch part 5′, and the first lock catch part 111′ is connected with the second lock catch part 5′ in a lock catch manner. By providing the connection assembly 2′, the lamp can be installed in a time-saving, labor-saving, efficient and safe manner, especially for the lamp with a heavy weight. A single person can complete the installation and disassembly, which reduces the installation cost and avoids damage to the lamp during the installation process. Through the relative sliding and locking connection between the first sliding part 221′ and the second sliding part 222′ and the relative sliding, relative rotation and buckle connection between the first connection assembly 21′ and the second connection assembly 22′, it can realize the up and down reciprocating movement of the entire lamp mounting structure 100′ and the space storage effect of the connection assembly 2′. Moreover, it can realize the self-locking effect of the lamp, avoid the risk of falling during installation process, and improve the convenience of installation.

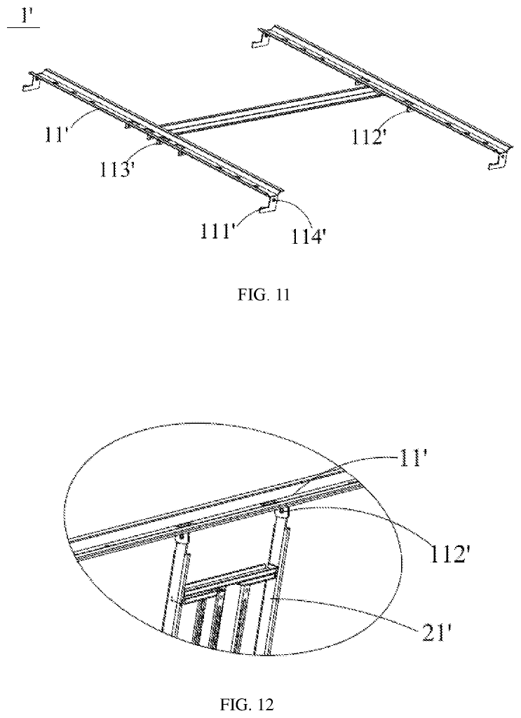

Please refer to FIG. 11 to FIG. 13, the structure of the mounting assembly 1′ of the present disclosure is basically the same as that of first example, and will not be described in detail here. The mounting assembly 1′ includes a pair of first mounting parts 11′ parallel to each other and a second mounting part 12′ perpendicular to the first mounting parts 11′ and located between the first mounting parts 11′. The first mounting part 11′ is provided with a first lock catch part 111′, the chassis assembly 3′ is provided with at least one second lock catch part 5′ at a position corresponding to the first lock catch part 111′, and the first lock catch part 111′ is connected with the second lock catch part 5′ in a lock catch manner. By arranging the locking engagement between the first lock catch part 111′ and the second lock catch part 5′, the installation difficulty of the lamp is reduced, the installation efficiency of the lamp is improved, single-person installation and disassembly is realized, and the installation cost is reduced. It should be noted that the specific number and arrangement positions of the first lock catch parts 111′ and the second lock catch parts 5′ are not limited in this disclosure, as long as the first lock catch part 111′ and the second lock catch part 5′ are arranged correspondingly, and the first lock catch part 111′ and the second lock catch part 5′ can also be flexibly determined according to the specific structure of the mounting assembly 1′ and the lamp.

Preferably, a first lock catch part 111′ is provided on the side of the first mounting part 11′ facing away from the mounting wall. There are four first lock catch parts 111′, each first lock catch part 111′ is located at the end of the first mounting part 11′, and first lock catch parts 111′ are symmetrically distributed on both sides of the first mounting part 11′. With such an arrangement, the lamp can be hung on the mounting assembly 1′ smoothly and with balanced force during the installation process.

Same as first example, the end of each first mounting part 11′ at the side of the first mounting part 11′ away from the mounting wall extends downwardly to form an L-shaped first lock catch part 111′. Preferably, the L-shaped first lock catch part 111′ is an L-shaped hook. The horizontal extension directions of respective hooks are the same to facilitate locking engagement with the second lock catch part 5′ on the chassis assembly 3′. The first lock catch part 111′ is further provided with a second locking hole 114′ for cooperating with the first locking hole 321′ in the chassis assembly 3′ to fixedly connect the chassis assembly 3′ and the mounting assembly 1′.

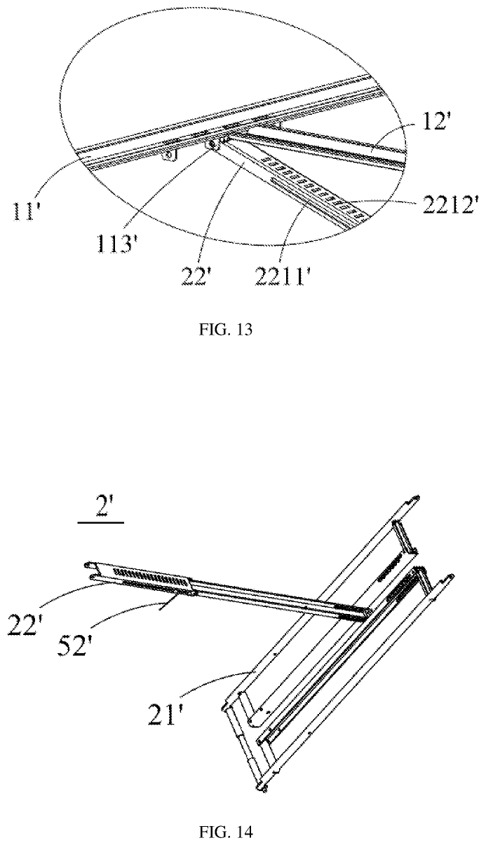

Please refer to FIG. 13 in conjunction with FIG. 11. The difference between the second example and the first example is that a fourth connection part 113′ is arranged on the first installation part 11′ that is not provided with the third connection part 112′ at the position corresponding to the second connection assembly 22′. The end of the second connection assembly 22′ away from the first connection assembly 21′ is used to rotatably connect the first mounting part 11′ and the second connection assembly 22′ through a connection piece, so that the second connection assembly 22′ can be rotated relative to the mounting assembly 1′.

Please refer to FIG. 14, the connection assembly 2′ of the present disclosure includes a first connection assembly 21′ and a second connection assembly 22′. The two ends of the first connection assembly 21′ are rotatably connected to the mounting assembly l′ and the chassis assembly 3′, respectively to form a first rotating part 2121′ and a second rotating part 2131′. One end of the second connection assembly 22′ is rotatably connected to the end of the first mounting part 11′ away from the first rotating part 2121′, and the other end of the second connection assembly 22′ is rotatably connected to the connection assembly 22′ located between the first rotating part 2121′ and the second rotating part 2131′.

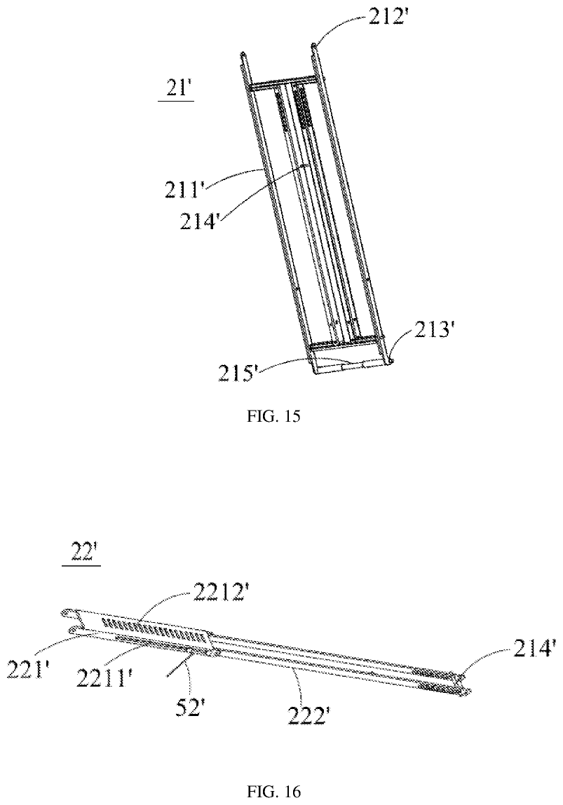

Please refer to FIG. 15, the first connection assembly 21′ has a structure similar to that of the connection assembly 2′ in first example, and includes a pair of connection rods 211′ parallel to each other and a first connection part 212′ and a second connection parts 213′ located at both ends of the connection rod 211′, the mounting assembly 1′ is rotatably connected to the first connection part 212′, and the chassis assembly 3′ is rotatably connected to the second connection part 213′ to form the first rotating part 2121′ and the second rotating part, respectively. A gap is provided between the two connection rods 211′ of the first connection assembly 21′, and the gap is used to receive the second connection assembly 22′, so as to facilitate the space storage effect of the connection assembly 2′ after the lamp is installed.

Please refer to FIG. 16 to FIG. 20, the second connection assembly 22′ includes a first sliding part 221′ and a second sliding part 222′. The first sliding part 221′ is rotatably connected to the fourth connection part 113′ of the mounting assembly 1′ through a connection piece. The connection piece can be a rotating pin, a rotating rivet or a rotating shaft, etc., which is not limited to this in this disclosure. The second sliding part 222′ is rotatably connected to the second connection assembly 22′ located between the first rotating part 2121′ and the second rotating part 2131′ through a second rotating shaft.

Furthermore, a guide groove 2211′ is provided on the side of the first sliding part 221′, and the guide groove 2211′ extends from the connection position between the first sliding part 221′ and the second sliding part 222′ towards a direction close to the fourth connection part 113′. The second sliding part 222′ is provided with a first guide shaft 2211′ that is matched and connected with the guide groove 2211′. The first sliding part 221′ and the second sliding part 222′ can slide relative to each other through the cooperation of the guide groove 2211′ and the first guide shaft 2211′, so as to drive the second sliding part 222′ and to move towards the first sliding part 221′ to retract.

Please refer to FIG. 16 to FIG. 20, the first sliding part 221′ is further provided with a plurality of position limiting grooves 2212′, and the plurality of position limiting grooves 2212′ are spaced apart in a direction parallel to the first guide shaft 2211′. A position limiting elastic piece 2222′ is provided at one end of the second sliding part 222′ close to the first guide shaft 2211′. One end of the position limiting elastic piece 2222′ is bent upward to form a buckle part 2223′. When the relative sliding between the second sliding part 222′ and the first sliding part 222′ parts 221′ is stopped, the second sliding part 222′ moves downward due to gravity, at this time, the buckle part 2223′ of the position limiting clastic piece 2222′ is automatically inserted into the position limiting groove 2212′ closest to the position limiting elastic piece 2222′ under the action of elastic force. The position limiting elastic piece 2222′ is locked with the position limiting groove 2212′ to complete the self-locking effect between the first sliding part 221′ and the second sliding part 222′.

Further, one end of the second sliding part 222′ away from the position limiting groove 2212′ is rotatably connected to the first connection assembly 21′ through the second guide shaft 214′. Specifically, a second guide rotating shaft 215′ is fixedly arranged on the first connection assembly 21′, and a rotating shaft slide groove 2224′ is provided at one end of the second sliding part 222′ close to the first connection assembly 21′. The second guide shaft 214′ passes through the rotating shaft slide groove 2224′, so that the second sliding part 222′ can slide relative to the first connection assembly 21′. Preferably, a gap 2226′ is provided between the top of the stuck slot 2225′ and the top of the side surface of the rotating shaft slide groove 2224′, and the second guide shaft 214′ can slide relatively in the rotating shaft slide groove 2224′ through the gap 2226′. Further, the stuck slot 2225′ is provided at the bottom of the side surface of the rotating shaft slide groove 2224′, and the stuck slot 2225′ is snap-connected to the second guide shaft 214′. When an external force is applied to the second sliding part 222′, the second guide shaft 214′ relatively slides in the rotating shaft slide groove 2224′ through the gap 2226′ under the action of the external force. When the external force is quickly released, under the action of the gravity of the lamp main body, the second guide shaft 214′ falls into the stuck slot 2225′ in the rotating shaft slide groove 2224′, and is connected with the stuck slot 2225′ in a snap manner, so that the second sliding part 222′ and the first connection assembly 21′ complete self-locking effect.

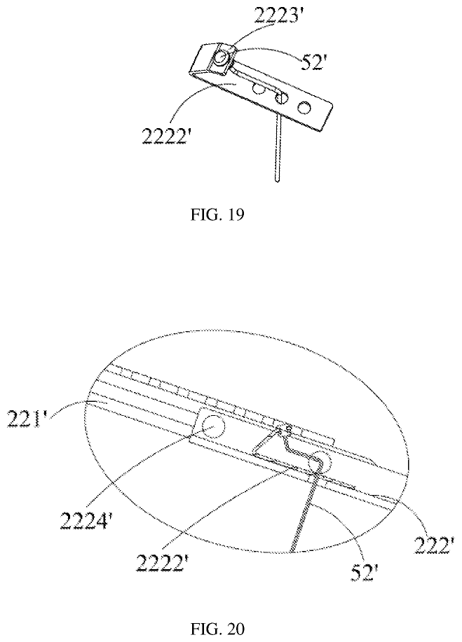

Please refer to FIG. 19 to FIG. 20, the lamp mounting structure 100′ further includes a detachment assembly 52′. One end of the detachment assembly 52′ is fixedly connected to the buckle part 2223′, and the other end of the detachment assembly 52′ extends out from the detachment hole in the second sliding part 222′. Preferably, the disassembly assembly 52′ is a steel wire rivet. The steel wire is wrapped around the rivet. The rivet is fixedly connected to the buckle part 2223′ of the position limiting elastic piece 2222′. The steel wire penetrates the position limiting elastic piece 2222′ and the second sliding part 222′ to protrude outward. The outward protruding part is received in the receiving space 33′ of the chassis assembly 3′, and the aesthetics of the lamp mounting structure 100′ can be improved by setting rubber plugs on the protruding part, and can avoid being scratched or damaged by steel wires during the installation and disassembly process. When the steel wire rivet is pulled, the position limiting elastic piece 2222′ can slide out from the position limiting groove 2212′ to unlock the locking connection between the first sliding part 221′ and the second sliding part 222′. At the same time, during the slow descent of the lamp main body, the first connection assembly 21′ and the second connection assembly 22′ are unlocked synchronously with the help of the weight of the lamp main body. By providing the disassembly assembly 52′, the locking connection between the first sliding part 221′ and the second sliding part 222′ and the snap-fit connection between the first connection assembly 21′ and the second connection assembly 22′ can be easily released, thereby achieving free installation and tool-free disassembly.

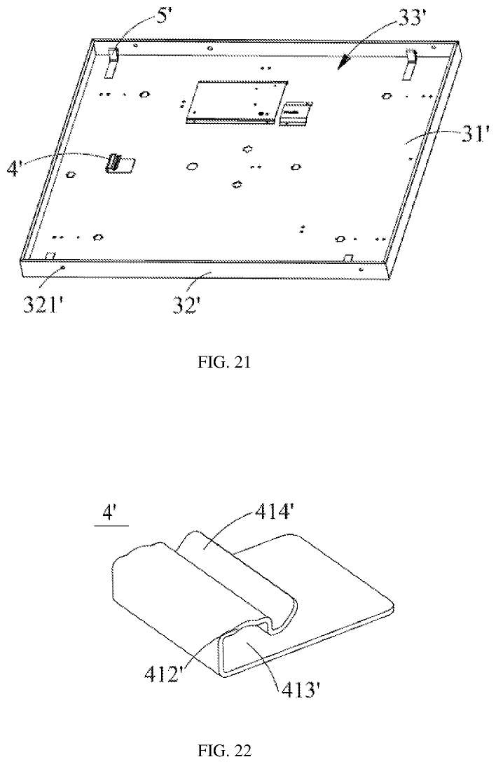

Please refer to FIG. 21, the chassis assembly 3′ includes a bottom plate 31′ and side walls 32′ surrounding the bottom plate 31′ and located at a periphery of the bottom plate 31′. The side walls 32′ extend from a periphery of the bottom plate 31′ towards a direction close to the mounting assembly 1′. The walls 32′ and the bottom plate 31′ jointly form a receiving space 33′ to receive the snap-fit assembly 4′, the second lock catch part 5′, and the connection assembly 2′, so that the chassis assembly 3′ can be installed on the mounting assembly 1 in a tight fit manner to improve the aesthetics of the lamp.

Please refer to FIG. 22, and in conjunction with FIG. 21, the lamp mounting structure 100′ further includes a snap-fit assembly 4′, which is fixedly connected to the side of the chassis assembly 3′ facing the connection assembly 2′, and the end of the first connection assembly 21′ away from the mounting assembly 1′ is rotatably connected to the chassis assembly 3′ through the snap-fit assembly 4′. The snap-fit assembly 4′ may be the same as the snap-fit assembly 4′ of first example, or may be different, which is not limited in this disclosure. Preferably, in this example, the snap-fit assembly 4′ is not exactly the same as the first example. The snap-fit assembly 4′ is not provided with the second snap-fit assembly 4′, but is bent downward and inward at the intersection of the bent part 412′ and the guide part 414′ for limiting the rotating shaft 215′ in the receiving groove 413′. Of course, the snap-fit assembly 4′ can also be configured in other structures, as long as it can be effectively engaged with the connection assembly 2′ to fix the lamp main body in the air and meet the transposition requirements for suspended operations.

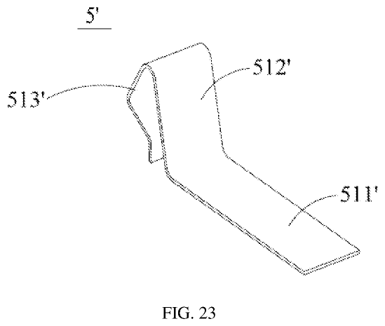

Please refer to FIG. 23 and in conjunction with FIG. 21, the second lock catch part 5′ of the second example of the present disclosure is shown. The second lock catch part 5′ includes a joint part 511′, a vertical part 512′, and a clamping part 513′ that are connected in sequence. The joint part 511′ is fixedly connected to the chassis assembly 3′, the vertical part 512′ is perpendicular to the joint part 511′, and the end of the vertical part 512′ away from the joint part 511′ is bent in a direction close to the vertical part 512′ to form a clamping part 513′, the clamping part 513′ is connected to the first lock catch part 111′ in a snap-fit manner to complete the locking connection between the chassis assembly 3′ and the mounting assembly 1′.

The present disclosure further provides a lamp with the aforementioned lamp mounting structure 100′, including a lamp main body and the aforementioned lamp mounting structure 100′. The lamp main body is fixedly connected to the side of the chassis assembly 3′ away from the connection assembly 2′.

When the lamp needs to be installed, first rotatably connect the first connection part 212′ of the first connection assembly 21′ and the first sliding part 221′ of the second connection assembly 22′ to the third connection part 112′ and the fourth connection part 113′ of the mounting assembly 1′, respectively, through the connection pieces, and then fixedly connect the mounting assembly 1′ with the connection assembly 2′ to the mounting wall, and then fixedly install the snap-fit assembly 4′ and the second lock catch part 5′ into the receiving space 33′ of the chassis assembly 3′, then fixedly connect the lamp main body to the side of the chassis assembly 3′ away from the connection assembly 2′ through a fixing piece. Pushing up the chassis assembly 3′ with the lamp main body is performed so that the second connection part 213′ of the second connection assembly 22′ is rotatably connected to the snap-fit assembly 4′.

At this time, due to the effective engagement of the connection assembly 2′ and the snap-fit assembly 4′, the lamp main body can be temporarily placed in the air to facilitate connection to the mains power, avoiding positioning difficulties due to line of sight, and providing higher visibility. When the chassis assembly 3′ is pushed upward, due to the lateral separation between the first connection assembly 21′ and the second connection assembly 22′, the second sliding part 222′ of the first connection assembly 21′ slides inward relative to the first sliding part 221′, stop pushing when it reaches a certain installation position. Because the external force disappears, the second sliding part 222′ moves downward due to gravity, and the position limiting elastic piece 2222′ automatically snaps into the nearest position limiting groove 2212′ under the action of elastic force, to complete the self-locking effect of the first sliding part 221′ and the second sliding part 222′. At this time, under the gravity of the lamp main body, the second guide shaft 214′ falls into the stuck slot 2225 in the rotating shaft slide groove 2224′, and is snap-connected with the stuck slot 2225′, so that the second sliding part 222′ and the first connection assembly 21′ complete the self-locking effect. With this arrangement, the lamp main body can be self-locked and stopped in the air at any time to facilitate connection to mains power or maintenance. Continue to push the chassis assembly 3′ upward until the first guide shaft 2211′ of the second sliding part 222′ contacts the highest point of the guide groove 2211′ of the first sliding part 221′. At this time, the first connection assembly 21′ moves around the guide groove 2211′ of the second connection assembly 22′ with the second guide shaft 214′ as a fulcrum to perform relatively sliding. The second connection assembly 22′ is received in the first connection assembly 21′. The second lock catch part 5 in the chassis assembly 3′ completes the locking connection with the first lock catch part 111′ of the mounting assembly 1′.

At this time, the fastener passes through the first locking hole 321′ in the chassis assembly 3′ and the second locking hole 114′ in the mounting assembly 1′, and the chassis assembly 3′ and the mounting assembly 1′ are fastened and fixed again, to improve the stability of the lamp.

When it is necessary to disassemble the lamp main body, remove the fasteners, remove the rubber plug, pull down the wire rivet, and the position limiting clastic piece 2222′ slides downward from the position limiting groove 2212′ to unlock the locking connection between the first sliding part 221′ and the second sliding part 222′. At the same time, during the slow descent of the lamp main body, the first connection assembly 21′ and the second connection assembly 22′ are synchronously unlocked with the help of the weight of the lamp main body. Moreover, due to the unique connection method between the mounting assembly 1′, the connection assembly 2′, and the chassis assembly 3′, when the first connection assembly 21′ and the second connection assembly 22′ are unlocked, the lamp main body is transposed at high altitude to unlock the locking connection between the clamping part and the first lock catch part 111′, and the lamp main body slowly leaves the mounting assembly 1′. Because of the effective engagement between the connection assembly 2′ and the snap-fit assembly 4′, the lamp main body can be temporarily fixed in the air, thereby preventing the lamp main body from falling rapidly, which may damage the lamp main body or cause safety accidents, and enabling quick installation and disassembly by one single person.

To sum up, in the lamp mounting structure 100 of the present disclosure and the lamp with the lamp mounting structure 100, by rotatably connecting the mounting assembly 1, the connection assembly 2, and the chassis assembly 3 end-to-end in sequence to form a Z-shaped structure, solving the problems of poor viewing angle when aligning and installing the lamp, and at the same time realizing the transposition requirement for suspended operations, making the installation process of lamps time-saving, labor-saving, efficient, and safe. Especially when installing heavy lamps, a single person can complete the installation and disassembly, thereby reducing the installing cost, and avoiding damage to lamps during installation. By arranging the guide of the connection assembly 2 and operating of the disassembly button 521, the installation efficiency can be improved, and the visibility of the installation process is high. In addition, the lamp mounting structure 100 and the lamp of the present disclosure can be installed independently and sold independently, thereby improving the versatility of respective structures and reducing the cost of the lamp.

The present disclosure provides a lamp mounting structure that is time-saving, labor-saving, efficient, safe, has high visibility, meets high-altitude transposition requirements, and can be installed and disassembled by a single person.

The present disclosure provides a lamp mounting structure, for assembling a lamp on a mounting wall, including: a mounting assembly, a connection assembly, and a chassis assembly, the mounting assembly is fixedly installed on the mounting wall, the chassis assembly is fixedly connected to a lamp main body, the mounting assembly, the connection assembly, and the chassis assembly are rotatably connected end-to-end in sequence to form a Z-shaped structure, the mounting assembly is provided with a first lock catch part, and at least one second lock catch part is provided on the chassis assembly at a position corresponding to the first lock catch part, and the first lock catch part is connected to the second lock catch part in a lock catch manner.

As a further improvement of the present disclosure, the connection assembly includes a pair of connection rods arranged in parallel and a first connection part and a second connection part respectively located at both ends of the connection rods, and the mounting assembly is rotatably connected with the first connection part, and the chassis assembly is rotatably connected with the second connection part.

As a further improvement of the present disclosure, the first connection part includes a first connection hole and a connection piece, and a side of the mounting assembly away from the mounting wall extends downward at a position corresponding to the first connection part to form a third connection part, and a second connection hole is provided in the third connection part at a position corresponding to the first connection hole, and the connection piece passes through the first connection hole and the second connection hole to rotatably connect the mounting assembly and the first connection part.

As a further improvement of the present disclosure, the lamp mounting structure further includes a snap-fit assembly, the snap-fit assembly is fixedly connected to a side of the chassis assembly facing the connection assembly, and the second connection part is rotatably connected to the chassis assembly through the snap-fit assembly.

As a further improvement of the present disclosure, the snap-fit assembly includes a first snap-fit member and a second snap-fit member, the first snap-fit member includes a first fixing part, and the first fixing part is fixedly connected to the chassis assembly, one end of the first fixing part is bent upward and inward to form a bent part, a receiving groove is formed between the bent part and the first fixing part, and a rotating shaft of the second connection part passes through the receiving groove and is rotatably connected to the first snap-fit member.

As a further improvement of the present disclosure, an end of the bent part extends towards a direction away from the first fixing part to form a guide part, and the second snap-fit member includes a second fixing part, the second fixing part is fixedly connected to the first fixing part, and an end of the second fixing part close to the bent part extends towards an interface part where the bent part and the guide part are connected to form a position limiting part, the position limiting part is in contact with the interface part for position limiting.

As a further improvement of the present disclosure, the second lock catch part includes a self-locking structure, the self-locking structure includes a slide rail, a sliding part, an elastic member, and a position limiting member, and the slide rail is fixedly installed on the chassis assembly and is slidably connected with the sliding part, a position of the sliding part corresponding to the first lock catch part is provided with a buckle part that is connected with the first lock catch part in a lock catch manner, and a side of the sliding part away from the buckle part is provided with a through hole, the position limiting member includes a position limiting shaft and a position limiting block vertically connected to the position limiting shaft, one end of the position limiting shaft away from the position limiting block passes through the through hole and is slidably connected to the sliding part, the elastic member is sleeved on the position limiting shaft and is clamped between the sliding part and the position limiting block.

As a further improvement of the present disclosure, the second lock catch part further includes a detachment assembly, the detachment assembly includes a detachment button and a transmission part, the transmission part is fixedly connected to the sliding part, and the disassembly button passes through the first fixing hole in a side wall of the chassis assembly and is fixedly connected to the transmission part to drive the sliding part to slide relative to the slide rail.

As a further improvement of the present disclosure, the transmission part is fixedly connected to sliding parts of two self-locking structures to drive the two sliding parts to slide synchronously.

Another object of the present disclosure is to provide a lamp including the above lamp mounting structure.

In order to achieve the object, the present disclosure provides a lamp, including a lamp main body and the above lamp mounting structure, the lamp main body is fixedly connected to a side of the chassis assembly away from the connection assembly.

The beneficial effects of the present disclosure are as follows. In the present disclosure, by rotatably connecting the mounting assembly, the connection assembly, and the chassis assembly end-to-end in sequence to form a Z-shaped structure, solving the problems of poor viewing angle when aligning and installing the lamp, and realizing the transposition requirement for suspended operations, making the installation process of lamps time-saving, labor-saving, efficient, and safe, especially when installing heavy lamps, a single person can complete the installation and disassembly, thereby reducing the installing cost, and avoiding damage to lamps during installation. By arranging the guide of the connection assembly and operating of the disassembly button, the installation efficiency can be improved, and the visibility of the installation process is high. In addition, the lamp mounting structure and the lamp of the present disclosure can be installed independently and sold independently, thereby improving the versatility of respective structures and reducing the cost of the lamp.

The above examples are only used to illustrate the technical solutions of the present disclosure and are not construed as any limitation thereto. Although the present disclosure has been described in detail with reference to the examples, those of ordinary skill in the art should understand that the technical solutions of the present disclosure can be modified or equivalently substituted without departing from the spirit and scope of the technical solution of this disclosure.

1. A lamp mounting structure, for assembling a lamp on a mounting wall, comprising: a mounting assembly, a connection assembly, and a chassis assembly, and wherein:
the mounting assembly is fixedly installed on the mounting wall,
the chassis assembly is fixedly connected to a lamp main body,
the mounting assembly, the connection assembly, and the chassis assembly are rotatably connected end-to-end in sequence to form a Z-shaped structure,
the mounting assembly is provided with a first lock catch part, and at least one second lock catch part is provided on the chassis assembly at a position corresponding to the first lock catch part, and
the first lock catch part is connected to the second lock catch part in a lock catch manner.

2. The lamp mounting structure according to claim 1, wherein:
the connection assembly comprises a pair of connection rods arranged in parallel and a first connection part and a second connection part located at both ends of the connection rods, and the mounting assembly is rotatably connected with the first connection part, and the chassis assembly is rotatably connected with the second connection part.

3. The lamp mounting structure according to claim 2, wherein:
the first connection part comprises a first connection hole and a connection piece, and a side of the mounting assembly away from the mounting wall extends downward at a position corresponding to the first connection part to form a third connection part, and a second connection hole is provided in the third connection part at a position corresponding to the first connection hole, and the connection piece passes through the first connection hole and the second connection hole to rotatably connect the mounting assembly and the first connection part.

4. The lamp mounting structure according to claim 2, wherein:
the lamp mounting structure further comprises a snap-fit assembly, the snap-fit assembly is fixedly connected to a side of the chassis assembly facing the connection assembly, and the second connection part is rotatably connected to the chassis assembly through the snap-fit assembly.

5. The lamp mounting structure according to claim 4, wherein:
the snap-fit assembly comprises a first snap-fit member and a second snap-fit member, the first snap-fit member comprises a first fixing part, and the first fixing part is fixedly connected to the chassis assembly, one end of the first fixing part is bent upward and inward to form a bent part, a receiving groove is formed between the bent part and the first fixing part, and a rotating shaft of the second connection part passes through the receiving groove and is rotatably connected to the first snap-fit member.

6. The lamp mounting structure according to claim 5, wherein:
an end of the bent part extends towards a direction away from the first fixing part to form a guide part, and the second snap-fit member comprises a second fixing part, the second fixing part is fixedly connected to the first fixing part, and an end of the second fixing part close to the bent part extends towards an interface part where the bent part and the guide part are connected to form a position limiting part, the position limiting part is in contact with the interface part for position limiting.

7. The lamp mounting structure according to claim 1, wherein:
the second lock catch part comprises a self-locking structure, the self-locking structure comprises a slide rail, a sliding part, an elastic member, and a position limiting member, and the slide rail is fixedly installed on the chassis assembly and is slidably connected with the sliding part, a position of the sliding part corresponding to the first lock catch part is provided with a buckle part that is connected with the first lock catch part in a lock catch manner, and a side of the sliding part away from the buckle part is provided with a through hole, the position limiting member comprises a position limiting shaft and a position limiting block vertically connected to the position limiting shaft, one end of the position limiting shaft away from the position limiting block passes through the through hole and is slidably connected to the sliding part, the elastic member is sleeved on the position limiting shaft and is clamped between the sliding part and the position limiting block.

8. The lamp mounting structure according to claim 7, wherein:
the second lock catch part further comprises a detachment assembly, the detachment assembly comprises a detachment button and a transmission part, the transmission part is fixedly connected to the sliding part, and the disassembly button passes through the first fixing hole in a side wall of the chassis assembly and is fixedly connected to the transmission part to drive the sliding part to slide relative to the slide rail.

9. The lamp mounting structure according to claim 8, wherein:
the transmission part is fixedly connected to sliding parts of two self-locking structures to drive the two sliding parts to slide synchronously.

10. A lamp, comprising: a lamp main body and a lamp mounting structure, wherein:
the lamp mounting structure is for assembling the lamp on a mounting wall, and comprises a mounting assembly, a connection assembly, and a chassis assembly, wherein:
the mounting assembly is fixedly installed on the mounting wall,
the chassis assembly is fixedly connected to a lamp main body,
the mounting assembly, the connection assembly, and the chassis assembly are rotatably connected end-to-end in sequence to form a Z-shaped structure,
the mounting assembly is provided with a first lock catch part, and at least one second lock catch part is provided on the chassis assembly at a position corresponding to the first lock catch part,
the first lock catch part is connected to the second lock catch part in a lock catch manner, and
the lamp main body is fixedly connected to a side of the chassis assembly away from the connection assembly.
